(19) United States
(12) Patent Application Publication
(10) Pub. No.: US 2007/0291143 A1
(43) Pub. Date: Dec. 20, 2007

(54) System And Method For The Production Of Composite Images Comprising Or Using One Or More Cameras For Providing Overlapping Images

(75) Inventors: Mauro Barbieri, Eindhoven (NL); Piotr Wilinski, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/575,511

(22) PCT Filed: Sep. 15, 2005
(86) PCT No.: PCT/IB05/53035

§ 371 Date: Mar. 19, 2007

(30) Foreign Application Priority Data
Sep. 24, 2004 (EP) 04104663.2

(51) Int. Cl. H04N 5/247

(52) U.S. Cl. 348/264; 348/E05.048

(57) ABSTRACT

System for the production of images the system comprising one or more cameras (2,3,4,2a,3a,4a) for providing overlapping images on a base (1), the system comprising a merger (5) for merging one or more overlapping images supplied by one or more of the cameras into a composite image (6). The merging process takes into account that the base is rotating with a rotational speed ω).

The invention relates to a system for the production of images, the system comprising one or more cameras for providing overlapping images on a base, the system further comprising a merger for merging overlapping images supplied by the one or more of the cameras into a composite image.

The invention also relates to a method for the production of images using one or more cameras wherein overlapping images are produced and overlapping images are merged into a composite image.

Such a system and method is known from U.S. Pat. No. 5,657,703. In said patent a system and method is described. The described image system comprises a plurality of video cameras on a base, each of which cameras captures an image, the data of each image forming a stream of digital or analog output. The images overlap and the streams are merged to form a panoramic or panospheric image. The system and device also comprises an image clipper to select a portion of the overall image. This portion may then be displayed on a display. Advances in digital storage and wireless communication make it possible to use such a video stream for entertainment.

This known system uses a fixed base.

Cameras, especially digital cameras, are becoming smaller, but also cheaper and more robust. This makes it possible to place them in almost any objects. The same type of solutions is breaking also into the consumer market.

In modern TV entertainment it becomes more and more interesting to place cameras in unusual locations which provide unique views such as e.g. bicycles during a race, formula I driver helmets, guitars. Such objects move.

The inventors have realized that especially for sports, but not exclusively for sport, rotatable objects are very interesting objects to place a camera in or upon, i.e. to be used as a base for the cameras. Examples are for instance balls such as soccer, American Football, basketball balls. Placing a camera on such rotatable objects, i.e. on a rotatable base provides an unique perspective, enabling a view direct from the centre of activity rather than from an outside point of view. Thus a system in which base object for the one or more cameras is a rotatable object, i.e. an object which when used is liable to rotate.

For such a system number of requirements should preferably be met:
The essential features of the object or its use are not noticeable changed.
A stable image is to be obtained.

The system as described in U.S. Pat. No. 5,657,703 is directed to the use of non-moving cameras. The base is in essence a fixed camera pedestal and the camera have a fixed point of view. For cameras mounted on rotatable objects, such as balls, the cameras move with respect to the image taken, even if they do not move with respect to the base (e.g. the ball) to which they are attached. The field of view of each camera changes causing apparent movement of objects within the field of view. Such apparent movement, even for relatively slow rotational speed may be large. This apparent movement may cause problems in merging (or stitching) of the overlapping images taken by the camera or cameras into one large image. “Overlapping” within the framework of the invention means that at least some parts of images comprise the same content matter. A priori the rotation (rotational speed, rotational axis) as well as the translational speed and direction of the object is unknown which complicates matters.

The present invention aims to provide a system and a method in or for which at least some of the mentioned problems are reduced.

The invention in its various aspects is based on the following insight.

When a static arrangement of cameras as in U.S. Pat. No. 5,657,073 is used the field of views and the overlap of the field of views covered by various cameras are relatively well defined. Thus the overlap of images is relatively well defined. The same, however, is not true when the camera or cameras are positioned on a rotating object such as a ball. The field of view of the camera(s) changes constantly in an a priori unknown manner. Furthermore cameras do not take pictures continuously but intermittently, for instance 50 images per second. Even at relatively small or moderate rotational speeds, for instance 2 rotations per second, a number of problems occur, which do not occur with a stationary plurality of cameras. One of these problems is the occurrence of blind spots in the panoramic image, i.e. parts of the overall image where inadvertently no image is taken during at least some time period. Another is an uncertainty of the field of overlap. The fields of overlap will constantly vary in an a priori unknown fashion.

To reduce such problems the system in accordance with a first aspect of the invention is characterized in that it comprises an image frequency determinator for determining the frequency at which images are taken by the one or more cameras in dependence on the rotation of the base.

A priori the rotation of the base is unknown. The larger the rotational speed, i.e. the number of rotations per second of the base to which the camera or cameras are attached, the larger the problems. By determining the frequency with which images are taken as a function of the rotation, more in particular in general increasing the frequency with which images are taken, i.e. the number of images taken per second, increases as the rotation increase. Taking more images as the object rotates faster increases the correspondence between subsequent images taken by a camera, making merging of images easier.

The frequency with which images are taken may be linearly dependent on the rotation of the object, or the camera may have a number of settings, e.g. low, middle and high speed. In embodiments wherein the system comprises a plurality of cameras the determinator may determine a common image frequency for all of the cameras, or in more sophisticated embodiments of the system the determinator may comprise a discriminator for providing differing image frequencies for different cameras.

The rotation of the object may be determined from the images taken, for instance the rotational frequency may be determined by the frequency with which a particular object is present in images taken by one of the camera, or it may be determined by a sensor within the rotatable object, for instance a strain gauge measuring centrifugal forces within the object as it rotates, or it may be determined by a sensor positioned outside the object, for instance a fixed separate camera following the object, wherein the object is provided with a marking, and the sensor measured the rotational speed by following the movement of this marking.

In simple embodiments the image frequency determinator is arranged for determining the frequency at which images are taken by the one or more cameras in dependence on the rotation frequency of the base. In more sophisticated embodiments the determinator is arranged for determining the frequency at which images are taken by the one or more cameras in dependence on the rotational frequency of the base and in addition on the orientation of the rotational axis and/or the translational speed.

In an embodiment the system comprise a selector for selection the resolution of the image as a function of image frequency. As the image frequency increases the total amount of data increases. By reducing the accuracy of the image, i.e. taking images at a lower resolution the total amount of data can still be kept in bounds. Doubling the frequency when the rotation is doubled while halving the resolution will still give an improved results, since, although the total amount of data per second stays the same, the difference between images is less and merging is easier.

This aspect of the invention is related to the frequency with which images are taken, i.e. timing of the time delay between images taken by a same camera as a function of rotational speed. This resolves at least some of the problems encountered in merging of images. This aspect of the invention relates to systems having one camera as well as to systems have a plurality of cameras. Based upon the same insight the inventors have realized that in systems where a plurality of cameras are used, advantages may be obtained by timing the taking of images taken by different cameras.

The system in accordance a second aspect of the invention is characterized in that system comprises a plurality of cameras and the system comprises a timer for mutually timing the instances at which images are taken at respective cameras.

‘mutually’ within the framework of the invention means that the instances at which images are taken are functionally related to each other and predetermined before the images are taken.

By using a timer to time the taking of images of different cameras, blind spots and uncertainty in the extent of the overlap of the fields of view can be avoided or at least reduced. Blind spots and varying overlaps of fields of view occur when a first and second adjacent camera whose instantaneous fields of view overlap take images some time apart. During this time the object may have rotated such that in fact there is no longer an overlap between the taken images, causing a blind spot or a much larger or varying overlap. A temporary blind spot in the overall image has then occurred. Such a blind spot makes merging of the image difficult. Varying fields of overlap also cause problems. By determining the times at which the image are taken and doing so coherently the occurrence of blind spots and problems with varying extent of overlap of fields of view may be avoided or at least reduced.

In a simple arrangement the timer is arranged such that in operation all cameras of the plurality of cameras take images simultaneously. In this simple arrangement the timer is arranged for synchronising at least as set of cameras, such that for said set taking of the images is synchronised. This reduces the occurrence of blind spots. The object cannot rotate between the taking of images by different cameras of the set of cameras, because the images are taken simultaneously.

In a variation on this arrangement the set of cameras comprises a number of subsets, wherein the timer is arranged such that in operation for each subset the cameras taken image simultaneously, but the timing of the subsets differ.

An example of such an arrangement is a ball having three subsets of 6 cameras, each subset providing a panospheric image. Suppose images are taken 50 times per second. If all subsets take images simultaneously 50 overall image of high quality is taken. If the timing of the subsets differ (for instance by 1/150 of a second) 150 overall images are taken (be it with fewer cameras). For a fast moving or rotating object the latter arrangement provides better results. Coherent timing of the instances at which the images for the various cameras are taken provides such advantage.

The system in preferred embodiments comprises a means for determining a rotational speed and the timer is arranged to vary timing in dependence of the determined rotational speed.

Variation of timing may be for instance such that the frequency of taking of images is dependent on the rotational speed, i.e. the higher the rotational speed, the more images are taken per second, as in the first aspect of the invention. The higher the rotational speed the higher the apparent speed of objects in the image. Increasing the frequency with which images are taken will increase image quality.

Variation of timing may also be done in a slightly different fashion. Merging of the objects can best be done by finding common objects within separate images. For stationary cameras such common objects are relatively easily found. However, for rotation objects, where the field of view changes drastically, such may not be so easy. By determining the rotational speed and comparing it to the timing, a course comparison of the field of views may be made to make a coarse determination of where in various images common objects may be found, which helps in merging the images into an overall image. This embodiment is in particular of importance when the system comprises a means, such as a clipper, to select a portion of the overall image. In contrast with the known system where the portion is stationary or quasi-stationary with respect to the fields of views of the cameras, such is not the case when the cameras are mounted on a rotating object such as a ball. For a pedestal viewing a playing field the position in respect of the various cameras of a goalkeeper will be known to some degree. However, for a rotating ball speeding towards a goalkeeper it will a priori not be known which camera captures the goalkeeper. By determining on the one hand the rotational speed (and possible also the overall speed) and on the other hand the instantaneous position of the goalkeeper within a field of view, the system in accordance with this embodiment times the taking of pictures for instance such that the goalkeeper is in the centre of fields of view when images are taken.

Rotational speed, as described above, may be determined by a rotational speed determinator, such as for instance a device which by measuring centrifugal forces determines the rotational axis or axes and the speed of rotation, or the rotational speed may be determined from previously taken images, wherein comparison of a sequence of images by finding common stationary objects allows the speed of rotation to be determined.

In embodiments the time differences, the rotational speed and or the translational speed, form inputs for the merger.

In embodiments the system, whether in the first or second aspect, may comprise sensors for determining deformation of the base.

A ball, when hit, may deform. This deformation will have its effects on the fields of view of the various cameras. By measuring deformation, for instance by sensors, information on the deformation is obtained, which information forms an input for the merger to be used in the merging of the image, or in the timing of taken images.

In an embodiment of the invention the system is arranged to generate a field of view independent of the actual images, when deformation exceeds a threshold.

When a ball is hit, the deformation may be so large that for a brief instance the image is either difficult to form, or in fact a true-to-life image is very confusing.

In preferred embodiments the system is arranged to provide a smooth transition between the image just prior to the hitting of the ball and an image a short time after hitting the ball.

The system in accordance with a second embodiment of second aspect of the invention is characterized in that it comprises a timer for establishing the timing the instances at which images have been taken at respective cameras.

“Establishing” within the framework of the invention means that after the images are taken, the time difference between the taking of images between various cameras is established. To some extent this embodiment is complementary to the first embodiment. However, instead of predetermining the timing, the system determines after the fact what time differences have occurred between various cameras. These time differences are an input to the merger. The invention encompasses those preferred embodiments described in respect of the first aspect in combination with the second aspect, in so far as such measures are commensurable with the second aspect. Sensors for deformation, sensors or other means for determination of rotational speed, means for selecting of a the overall image at least may be used for this second embodiment of the second aspect.

The first and second aspect relate in the various embodiments all relate to timing of the taking of images. The third aspect of the invention relates to the merger itself.

The system in accordance with a third aspect of the invention is characterized in that the merger comprises a motion estimator for estimating motion vectors between images, wherein the motion estimator is so arranged that it has an input for a rotational parameter of the base.

Motion estimation is a known technique in which images are compared to find common objects and motion vectors describing the apparent motion of such an object between the compared images.

For such a motion estimation usually use is made of a library of motion vectors. The inventors have realized that known motion estimation techniques would require a very large range in possible motion vectors. In fixed systems the motion of object is rather limited. Most of the image is static and only a few objects move within the image. Even when motion estimation is used for for instance compensating a shaking of the image, or panning of an image the motion is rather simple, the whole image is shaken or moves in a more or less regular manner. So the choice of motion vectors is rather limited and usually relatively simple. However, the inventors have realized that when the base is rotating at an a priori unknown rotational frequency and a priori unknown translational speed the situation is very different. The apparent motion of objects varies widely in time and space. Consequently the motion estimation is much more difficult. In fact this also relates to the timing of images. The differences between images to be merged varies widely. It is not a priori known how much motion there is due to the unknown rotation of the object. In the third aspect of the invention the characteristics of the rotation (rotational speed and/or orientation of rotational axis) form an input for the motion estimator. The rotational parameters make it possible to direct a range finder to an set of possible motion vectors thus requiring less time and effort to estimate the motion. Beside the characteristics of the rotation of the base, the motion estimator may also have an input for characteristics of the translation (speed and/or direction). In effect this third aspect of the invention also relates to timing, the input of the rotational speed combined with knowledge of time delays (i.e. timing) between images (whether between consecutive images taken by one and the same camera or images taken by different cameras) will provided information allowing first order estimation of motion vectors. This allows the motion estimator to determine, starting from this first order approximation for the motion vector relatively fast the actual motion vectors.

In a preferred embodiment the estimation techniques are independent of the orientation of the camera. In standard motion estimation techniques the estimator uses different algorithms for the horizontal direction and the vertical direction. Basically it is usually assumed that there is a much larger probability for a motion in a horizontal direction then for a vertical direction. Cameras are always held and oriented as they are supposed to be held (i.e. bottom part down) and most movements are from left to right and vice versa. Thus is make sense for the known motion estimation systems to use the available computing power in the most efficient way and discriminate between horizontal and vertical motion.

However, for a rotatable object, it is not known how the cameras will be oriented, and all directions should preferably be treated on an equal basis.

Preferably the cameras take images with equal resolution and extent in horizontal and vertical direction.

These and further aspects of the invention will be explained in greater detail by way of example and with reference to the accompanying drawings, in which

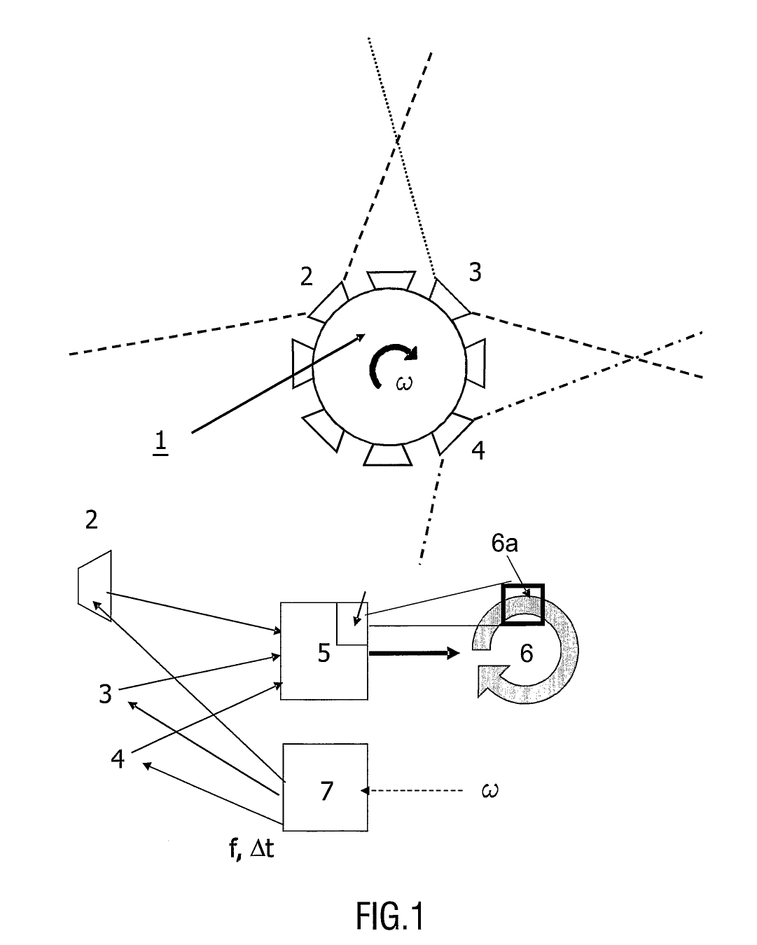

FIG. 1 illustrates schematically a system in accordance with the invention;

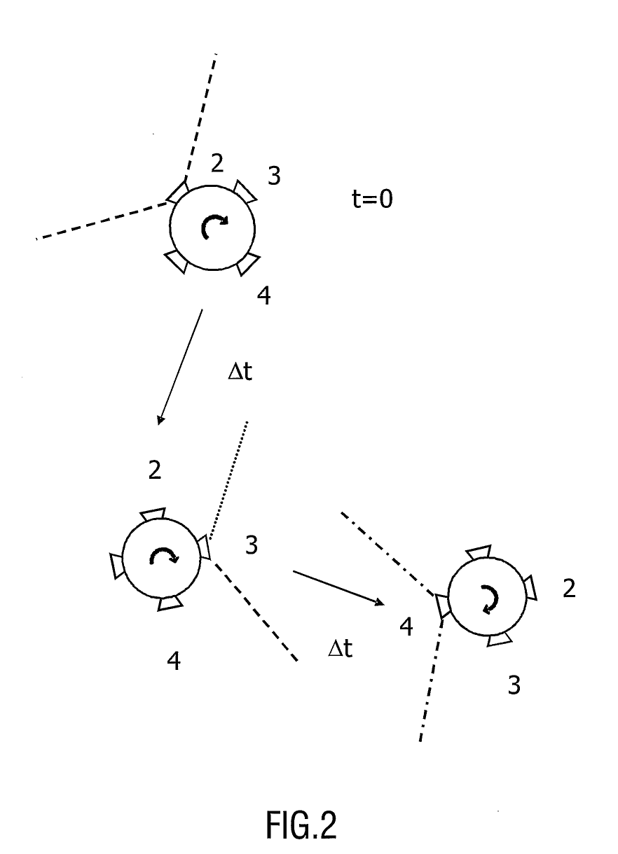

FIG. 2 illustrates a problem the present invention seeks to overcome;

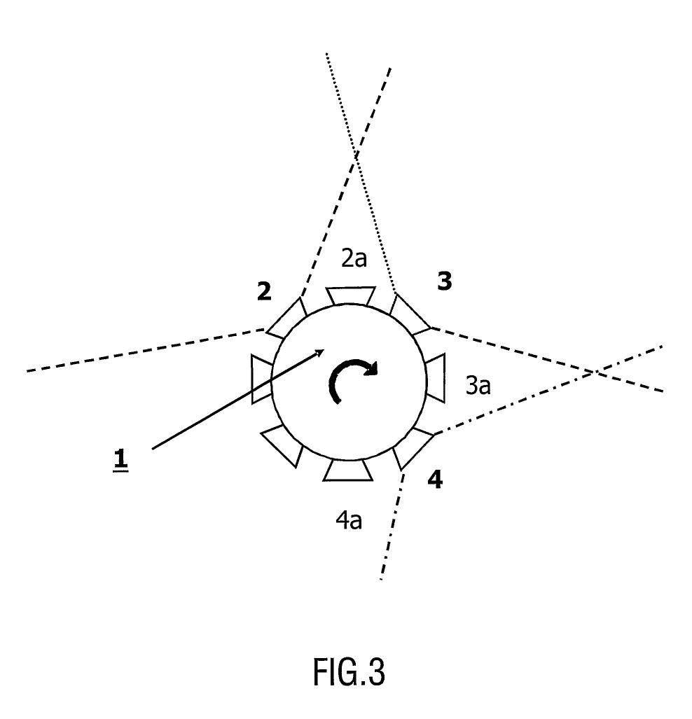

FIG. 3 illustrates a preferred embodiment;

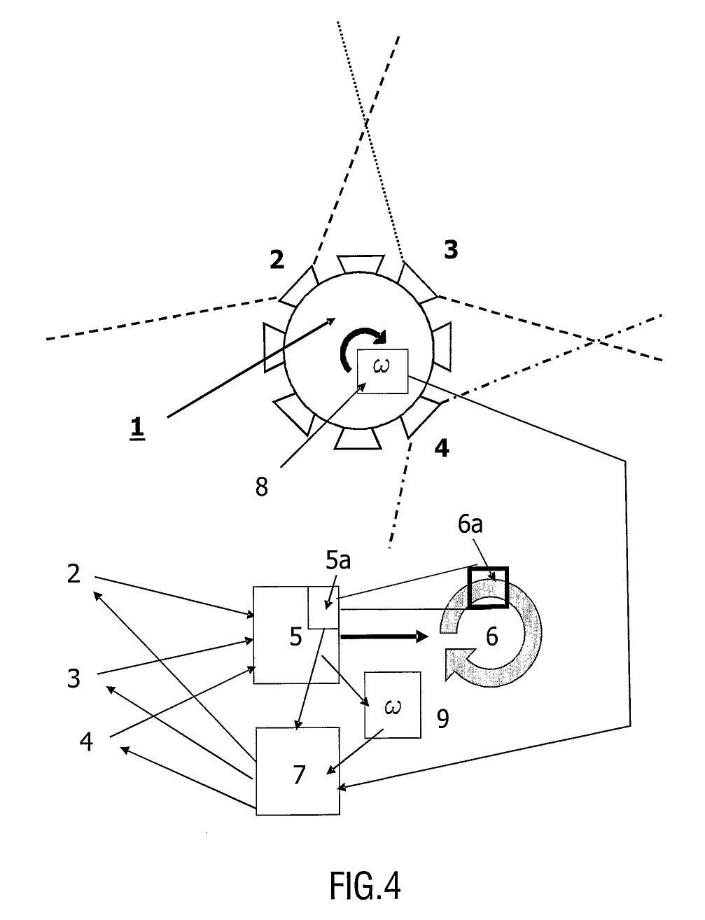

FIG. 4 illustrates a further preferred embodiment;

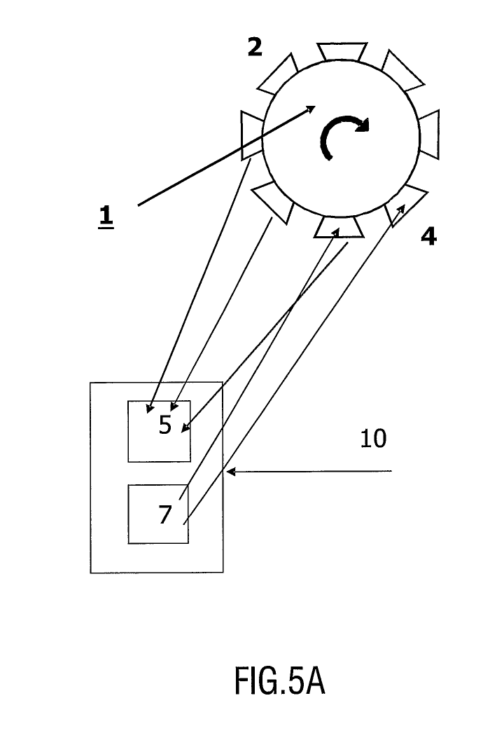

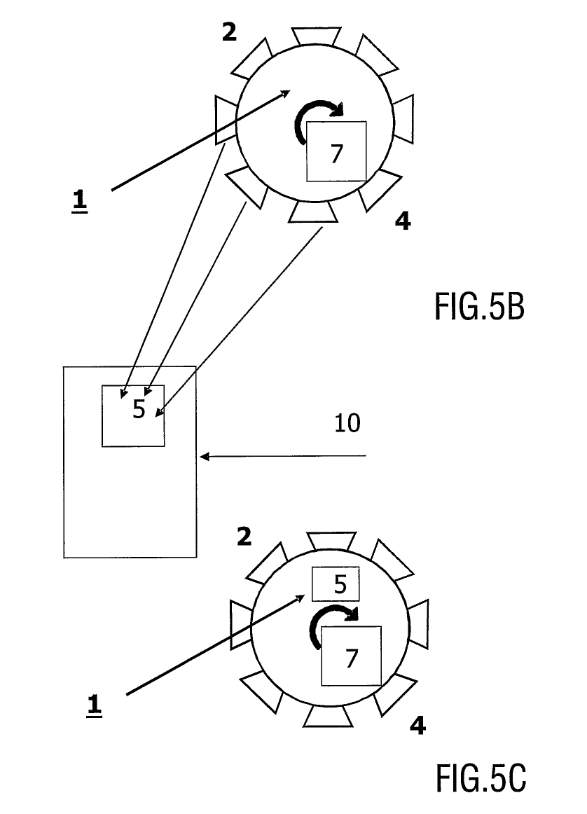

FIGS. 5A to 5C illustrate various embodiments of the system.

The Figs. are not drawn to scale. Generally, identical components are denoted by the same reference numerals in the figs.

FIG. 1 illustrates schematically a system in accordance with the a first and/or second aspect of the invention. The system comprised a rotatable base 1, such as for instance a ball, comprising a plurality of cameras 2, 3 and 4. These cameras each have their field of view, in FIG. 1 schematically indicated by the dotted lines. The fields of view overlap at least partially. The signals from the cameras 2, 3, 4 etc are fed into a merger, which merges the various images into an overall image 6, in FIG. 1 schematically indicated by a round arrow. The system may comprise a means 5a to select a portion 6a of the image to be displayed, more closely observed or recorded. The fields of view overlap without rotation.

The system comprises a timer 7 to time the taking of images of the cameras 2, 3 4 etc. The timer in the first aspect of the invention is a determinator for determining the frequency (f) of the images, i.e. how many images are taken per second and/or a timer to determine the time (Δt) between images taken. To this end the timer has an input for the rotational frequency ω or other data relating to said rotation.

FIG. 2 illustrates the taking of images in which camera one takes an image at t=0, some time Δt later camera 2 takes an image, and thereafter camera 3 takes an image, then camera 4 takes an image and subsequently camera 1 (in this example thus after a delay of 4Δt) takes an image after which the cycle repeats itself. In between the taking of images, whether it relates to consecutive images taken by one camera or images taken by different cameras the base has however rotated, so that in effect the fields of view of the images taken by various cameras or by the same camera do not overlap or at least the overlap is not a priori known Therefore temporarily there may be black spots in the overall image. Depending on the speed of rotation, the nominal overlap and the direction of rotation greatly varying fields of overlap may result. Merging of the images becomes difficult, because the extent of overlap of images is not known. In the first aspect of the invention the timer 7 has an input for data on the rotation of the object and, in dependence on the rotation of the object determines the frequency with which images are taken. The larger the rotation the higher the frequency. This reduces the occurrence of black spots and increases the extent and likelihood of overlap between images. The frequency with which images are taken may be linearly dependent on the rotation of the object, or the camera may have a number of settings, e.g. low, middle and high. In embodiments wherein the system comprises a plurality of cameras the determinator may determine a common image frequency for all of the cameras, or in more sophisticated embodiments of the system the determinator may comprise a discriminator for providing differing image frequencies for different cameras. For instance, the apparent speed of objects for cameras that are positioned and rotate perpendicular to the axis of rotation of the base is substantially larger than for cameras that are positioned on the axis. Taking for instance an American soccer ball, the image taken by a camera on the front and back tip of the ball will, although it rotates, change less in content, then for cameras positioned on the circumference of the ball.

The rotation of the object may be determined by the images taken, for instance the rotational frequency c may be determined by the frequency with which a particular object is present in images taken by one of the camera, it may also be determined by a sensor within the rotatable object, for instance a strain gauge within a ball measuring centrifugal forces within the ball as it rotates, or it may be determined by a sensor positioned outside the object, for instance a fixed separate camera following the object, wherein the object is provided with a marking, and the sensor measured the rotational speed by following the movement of this marking.

In simple embodiments the image frequency determinator (7) is arranged for determining the frequency at which images are taken by the one or more cameras in dependence on the rotational frequency of the base. In more sophisticated embodiments the determinator is arranged for determining the frequency at which images are taken by the one or more cameras in dependence on the rotational frequency of the base and/or the orientation of the rotational axis and/or the translational speed wherein the determinator increases the image frequency the higher the translational speed. Translational speed may be determined from the images taken previously, a sensor within the base (for instance a sensor as used in airplanes to measure ground speed) or by means of a separate camera or speed gun.

The system and method in accordance with a second aspect of the invention relates to mutual timing of the taking of images by different cameras.

In a simple embodiment a simple timing arrangement is used, which is independent of the rotational frequency of the base: images are taken simultaneously. By synchronizing the images of the various cameras at least one disadvantageous effect of rotation is removed, since there is no time difference Δt between the images and the extent of overlap of images taken by adjacent cameras is at least in first order approximation known. This reduces problems with merging of the images, and avoids the occurrence of black spots.

A preferred embodiment is schematically shown in FIG. 3.

The system comprises two sub-sets of cameras 2, 3, 4 and 2a, 3a, 4a. Within both sub-sets the cameras are synchronized. However, there is a time difference between the synchronization of both subsets. This allows the system to provide a higher rate of taking of images. The time difference between the sets may be dependent on the speed of rotation wherein, which in effect would constitute a system and method in which first and second aspect of the invention are combined. For instance the time difference between the subsets is zero at low rotational speed (allowing to take very high definition images) but at higher rotational speeds there is an interval between the triggering of both subsets equal to half the interval between images within a subset which allows for a better image reproduction.

FIG. 4 schematically illustrates a preferred embodiment. This embodiment is similar to the one shown in FIG. 1, but the system itself comprise a means for determining the rotational speed ω. Such a means may be comprised in the rotatable base itself, e.g. in the form of a device which measures centrifugal forces, the strength and direction of which forces are dependent on the rotational axis and rotational speed ω. Schematically such a device 8 is indicated in FIG. 4. Alternatively the rotational speed (and direction) may be deduced from the image(s) itself by a rotational speed determinator 9. Rotational speed may for instance be determined by identifying fixed, relatively far away objects such a goalposts, corners, 50-yard line, 10 yard sign, basket, and counting the frequency with which such objects enter in and disappear out of the field of view captured by one or more cameras. The rotational axis may be determined by finding the cameras for which far way object execute a small circle within the field of view. The rotational speed and/or the rotational axis is an input for the timer 7 and the timing of the cameras is dependent on the rotational speed. A simple arrangement is for instance one in which the frequency of taking images (number of images per second) is dependent on the rotational speed, wherein the higher the rotational speed the more images per second are taken. The timing may also, in preferred embodiment be dependent on the selected portion 6a of the overall image. For instance, the frequency with which those cameras not directed to the selected portion or a portion near to the selected portion take images, may be less than for the cameras directed to the selected portion. This would mean that relatively more information is gathered on the selected portion than on the rest of the image.

FIGS. 5A, 5B and 5C illustrates various possible arrangements for a system in accordance with the invention.

In FIG. 5A the system comprises a rotatable base, such as a ball, which comprises the cameras. The merger 5 and the timer 7 are remote from the base, for instance in a base computer 10. An advantage is that the merger and the timer are not subjected to the shocks and bounds that the base, especially when it is for instance a soccer or American football, is subjected to. The disadvantage is that all data is to be transmitted between the base and the base computer.

FIG. 5B shows a system in which the timer 7 is comprised in the rotatable base. This may be advantageous when for instance timing is dependent on the rotational speed and such is measured in the ball itself.

FIG. 5C illustrates a devices in which merging is done in the base itself. The advantage is that less data is transmitted from the ball to the computer 10. The clipper may still be comprised in the base computer.

The device may comprise a device for measuring deformation. The device for measuring rotational speed may double as a device for measuring deformation for instance when strains are measured. Strains indicated force on the ball, such forces may indicate deformations as well as centrifugal forces. Because deformations cause cameras to be moved in respect of each other, information on deformations is useful information for merging of images.

The above aspect of the invention relate to timing of the taking of overlapping images before merging said image into a composite image is performed.

A third aspect of the invention relates to the merger itself. In this aspect the merger comprises a motion estimator, i.e. an algorithm with which apparent motion of common objects in different images is estimated. Such estimation helps in merging of the images into the composite image. The inventors have realized that for cameras on rotatable objects data on the timing of the images, in combination with rotational speed, is important and can be used to advantage.

Motion estimation is a known technique in which images are compared to find common objects and motion vectors describing the apparent motion of such an object between the compared images.

For such a motion estimation usually use is made of a library of motion vectors. The inventors have realized that known motion estimation techniques would require a very large range in possible motion vectors. In fixed systems the motion of object is rather limited. Most of the image is static and only a few objects move within the image. Even when motion estimation is used for for instance compensating a shaking of the image, or panning of an image the motion is rather simple, the whole image is shaken or moves in a more or less regular manner. So the choice of motion vectors is rather limited and usually relatively simple. However, the inventors have realized that when the base is rotating at an a priori unknown rotational frequency and a priori unknown translational speed the situation is very different. The apparent motion of objects varies widely in time and space. Consequently the motion estimation is much more difficult. In fact this also relates to the timing of images. The differences between images to be merged varies widely. It is not a priori known how much motion there is due to the unknown rotation of the object. In the third aspect of the invention the characteristics of the rotation (rotational speed and/or orientation of rotational axis) form an input for the motion estimator. The rotational parameters make it possible to direct a range finder to a set of possible motion vectors thus requiring less time and effort to estimate the motion. Beside the characteristics of the rotation of the base, the motion estimator may also have an input for characteristics of the translation (speed and/or direction). In effect this third aspect of the invention also relates to timing, the input of the rotational speed combined with knowledge of time delays (i.e. timing) between images (whether between consecutive images taken by one and the same camera or images taken by different cameras) will provide information allowing first order estimation of motion vectors. This allows the motion estimator to determine, starting from this first order approximation for the motion vector relatively fast the actual motion vectors.

Within the concept of the invention a ‘merger” and “timer” as well as “means for recording” etc. etc. is to be broadly understood and to comprise e.g. any piece of hard-ware (such a merger, timer, recorder), any circuit or sub-circuit designed for merging images, time the taking of images, recording etc. as described as well as any piece of soft-ware (computer program or sub program or set of computer programs, or program code(s)) designed or programmed to take such action in accordance with the invention as well as any combination of pieces of hardware and software acting as such, alone or in combination, without being restricted to the above or below given exemplary embodiments.

The invention is also embodied in any computer program comprising program code means for performing a method in accordance with the invention when said program is run on a computer as well as in any computer program product comprising program code means stored on a computer readable medium for performing a method in accordance with the invention when said program is run on a computer, as well as any program product comprising program code means for use in a system in accordance with the invention, for performing the action specific for the invention.

It will be appreciated by persons skilled in the art that the present invention is not limited by what has been particularly shown and described hereinabove. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

1. System for the production of images the system comprising one or more cameras (2, 3, 4, 2a, 3a, 4a) for providing overlapping images on a base (1), the system comprising a merger (5) for merging one or more overlapping images supplied by one or more of the cameras into a composite image (6), wherein the system comprises an image frequency determinator (7) for determining the frequency (f, Δt) at which images are taken by the one or more cameras (2,3, 4, 2a, 3a, 4a) in dependence on the rotation (ω) of the base (1).

2. System as claimed in claim 1, wherein the determinator (7) is arranged for determining the frequency (f, Δt) at which images are taken by the one or more cameras (2,3, 4, 2a, 3a, 4a) in dependence on the rotational frequency (ω) of the base (1) and in addition on the orientation of the rotational axis and/or the translational speed of the base.

3. System as claimed in claim 1, wherein the system comprise a selector for selection the resolution of the image as a function of image frequency.

4. System for the production of images the system comprising a plurality of cameras (2, 3, 4, 2a, 3a, 4a) for providing overlapping images on a base (1), the system comprising a merger (5) for merging one or more overlapping images supplied by one or more of the cameras into a composite image (6), wherein the system comprises a timer (7) for mutually timing the instances at which images are taken at respective cameras (2, 3, 4, 2a, 3a, 4a).

5. System as claimed in claim 4, wherein the timer is arranged for synchronizing at least a set of cameras.

6. System as claimed in claim 5, wherein the set of cameras comprises a number of subsets, wherein the timer is arranged such that in operation for each subset the cameras taken image simultaneously, but the timing of the subsets differ.

7. System as claimed in claim 4, wherein the system comprises a means for determining a rotational speed of the base (1) and the timer is arranged to vary timing in dependence of the determined rotational speed.

8. System for the production of images the system comprising a plurality of cameras (2, 3, 4, 2a, 3a, 4a) for providing overlapping images on a base (1), the system comprising a merger (5) for merging one or more overlapping images supplied by one or more of the cameras into a composite image (6), wherein the system comprises a timer for establishing the timing of the instances at which images have been taken at respective cameras.

9. System as claimed in claim 1, wherein the system comprises sensors for determining deformation of the base.

10. System for the production of images the system comprising one or more cameras (2, 3, 4, 2a, 3a, 4a) for providing overlapping images on a base (1), the system comprising a merger (5) for merging one or more overlapping images supplied by one or more of the cameras into a composite image (6), wherein the merger comprises a motion estimator for estimating motion vectors between images, wherein the motion estimator is so arranged that it has an input for a rotational parameter of the base.

11. System as claimed in claim 10 wherein the motion estimator comprises an input for also the translational motion of the base.

12. Method for the production of a composite image using one or more cameras on a rotatable base wherein overlapping images are provided by the one or more cameras and one or more of the overlapping images are merged into a composite image wherein the frequency of the taking of images is related to the rotation of the object.

13. Method for the production of a composite image using a plurality of cameras on a rotatable base wherein overlapping images are provided by the cameras and one or more of the overlapping images are merged into a composite image wherein the cameras are mutually timed.

14. Method as claimed in claim 13, wherein the plurality of cameras comprises at least one set of cameras which are synchronized.

15. Method as claimed in claim 14, wherein the plurality of cameras comprises at least two sub sets of cameras wherein for each subset the cameras are synchronized, but the timing of the subsets differ.

16. Method for the production of a composite image using one or more cameras on a rotatable base wherein overlapping images are provided by the one or more cameras and one or more of the overlapping images are merged into a composite image wherein motion estimation is used and the motion estimation is dependent on the rotation of the base.

17. Method as claimed in claim 12 wherein the rotation of the base is measured by a sensor in the base.

18. Computer program comprising program code means for performing a method in accordance with a method as claimed in claim 12 when said program is run on a computer.

19. Computer program product comprising program code means stored on a computer readable medium for performing a method in accordance with a method as claimed in claim 12 when said program is run on a computer.
